(19) United States
(12) Patent Application Publication
(10) Pub. No.: US 2009/0274369 A1
(43) Pub. Date: Nov. 5, 2009

(54) IMAGE PROCESSING DEVICE, IMAGE PROCESSING METHOD, PROGRAM, AND STORAGE MEDIUM

(75) Inventors: Shinji Sano, Kawasaki-shi (JP); Hiroshi Kaburagi, Yokohama-shi (JP); Tsutomu Sakaue, Yokohama-shi (JP); Takeshi Namikata, Yokohama-shi (JP); Manabu Takebayashi, Isehara-shi (JP); Reiji Misawa, Tokyo (JP); Osamu Iinuma, Machida-shi (JP); Naoki Ito, Tokyo (JP); Yoichi Kashibuchi, Tokyo (JP); Junya Arakawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/369,995

(22) Filed: Feb. 12, 2009

(30) Foreign Application Priority Data
Feb. 14, 2008 (JP) 2008-033574

(51) Int. Cl. G06K 9/18; G06F 17/30

(52) U.S. Cl. 382/182; 707/100

(57) ABSTRACT

An image processing device includes a dividing unit for dividing objects of an input image, a metadata adding unit for adding metadata to each of the divided objects by performing OCR processing and morpheme analysis, a display unit for displaying at least one of the divided objects and the metadata added to the divided object, and a metadata accuracy determining unit for determining accuracies of the added metadata. The display unit preferentially displays metadata determined as being low in accuracy by the metadata accuracy determining unit.

### BACKGROUND OF THE INVENTION

1. Field of the Invention

The present invention generally relates to an image processing device, an image processing method, a program, and a storage medium for accumulating input images in a recording device and editing images.

2. Description of the Related Art

In a conventional image processing device, a document image is read by a scanner, and the image is converted into a format which can be relatively easily reused and decomposed, and saved in a recording device.

When saving the decomposed images in a recording device, metadata may be added to each image to improve retrieval performance when they are reused later. As a result, a user may be able to relatively easily find an image.

The metadata can include an area and size of an image, user's information, a location where an image reading device is installed, an input time of the image, and in addition, a character code extracted from the image itself or an image with highly relevant data.

FIG. 32A to FIG. 32D show a process of extraction of characters from an image read by an image processing device. That is, FIG. 32A shows an example of an image to be read by the image processing device, and FIG. 32B shows character regions extracted from the image. FIG. 32C shows extracted character codes lined up, and FIG. 32D shows the character codes decomposed by lexical category by analyzing the morphemes thereof.

When the image shown in FIG. 32A is input into the image processing device, as shown in FIG. 32B, character regions may be extracted based on an amount of color differential edge in the image. Then, as shown in FIG. 32C, optical character recognition (OCR) may be performed, and characters included in character regions can be converted into character codes. Further, the obtained character codes may be subjected to morpheme analysis. This morpheme analysis decomposes a natural language character string into minimum unit phrases having grammatical meanings called morphemes. Then, as shown in FIG. 32D, the character codes may be decomposed by lexical category.

The results of this process may be added as metadata to the input image.

However, when the accuracy of OCR or morpheme analysis is not sufficient, incorrect metadata may be added to the image. Therefore, a user may be required to manually search for the incorrect metadata and check whether the data are correct or incorrect, and when the metadata are incorrect, the user may be required to provide a unit for correcting these metadata. As the unit for correcting metadata, for example, one that is available is disclosed in Laid-Open No. 2000-268124.

However, if the number of images to be accumulated and managed by the image processing device increases, the number of manual operations and the time that may be required for the manual operations can increase accordingly. As a result, usability may be deteriorated.

At present, a method in which an input image is divided not by page, but into image units called objects of characters, graphics, line drawings, tables, and photographs and accumulated as vector images, is considered. When carrying out this method, in comparison with an image processing device in which images are accumulated on a page basis, the number of images to be accumulated for operating and the number of metadata may increase, so that search, incorrect/correct check, and the number of correcting operations to be performed by a user and a time for these may further increase.

Therefore, there remains a need for an image processing device and an image processing method having relatively high usability which reduces the number of manual operations to be performed by a user and a time that may be necessary in the above-described image processing device.

### SUMMARY OF THE INVENTION

According to one aspect of the invention, an image processing device is provided that includes a dividing unit for dividing objects of an input image, a metadata adding unit for adding metadata to each of the divided objects by performing OCR and morpheme analysis, a display unit for displaying at least one of the divided objects and the metadata added to the divided object, and a metadata accuracy determining unit for determining accuracies of the added metadata. The display unit preferentially displays metadata determined as being low in accuracy by the metadata accuracy determining unit.

Further features of the present invention will become apparent from the following description of exemplary embodiments, with reference to the attached drawings.

### BRIEF DESCRIPTION OF THE DRAWINGS

FIG. 1 is a block diagram showing an embodiment of a system including an image processing device according to aspects of the present invention;

FIG. 2 is a block diagram showing an embodiment of the MFP shown in FIG. 1;

FIG. 3 is a view showing an example of a first data processing flow of an embodiment;

FIG. 4 is a view showing an example of a processing flow for adding metadata of an embodiment;

FIG. 5 is a view showing an example of a processing flow for reading from a scanner according to an embodiment;

FIG. 6 is a view showing an example of a processing flow for converting data from a PC into bitmap data according to an embodiment;

FIG. 7 is a view showing an example of a result of object division;

FIG. 8 is a view showing an example of block information of each attribute and input file information at the time of object division;

FIG. 9 is a flowchart showing an example of vectorization processing according to an embodiment;

FIG. 10 is a view showing an example of corner extraction processing in the vectorization processing;

FIG. 11 is a view showing an example of contour compiling processing in the vectorization processing;

FIG. 12 is a flowchart showing an example of grouping processing of vector data generated through the vectorization processing shown in FIG. 9;

FIG. 13 is a flowchart showing an example of figure element detection processing applied to vector data grouped through the grouping processing shown in FIG. 12;

FIG. 14 is a view showing an example of a data structure of a vectorization processing result according to an embodiment;

FIG. 15 is a flowchart showing an example of application data conversion processing;

FIG. 16 is a flowchart showing an example of document structure tree generation processing;

FIG. 17 is a view showing an example of a document to be subjected to the document structure tree generation processing;

FIG. 18 is a view showing an example of a document structure tree generated through the document structure tree generation processing;

FIG. 19 is an example of a SVG format according to an embodiment;

FIG. 20 is a view showing an example of UI display according to an embodiment;

FIG. 21 is a view showing an example of page display in the UI display according to a present embodiment;

FIG. 22 is a view showing an example of object attribute display in the UI display according to an embodiment;

FIG. 23 is a view showing an example of display of one object of divided objects in the UI display according to an embodiment;

FIG. 24 is a view showing an example of display of an object and metadata in the UI display according to an embodiment;

FIG. 25 is a block diagram of an example of processing to be performed by image processing devices according to embodiments of the invention;

FIG. 26 is a view showing an example of a user interface of the image processing device according to an embodiment;

FIG. 27 is a view showing an example of a user interface of the image processing device according to an embodiment;

FIG. 28 is a block diagram of an example of processing to be performed by an image processing device according to an embodiment;

FIG. 29 is a view showing an example of relationships between objects relating to each other and metadata thereof;

FIG. 30 is a view showing an example of a user interface of the image processing device according to an embodiment;

FIG. 31A is a view describing an example of correction of metadata according to an embodiment;

FIG. 31B is a view describing an example of correction of metadata according to an embodiment;

FIG. 32A is a view showing an example of processes of character region recognition, OCR, and morpheme analysis to be applied to an input image;

FIG. 32B is a view showing an example of processes of character region recognition, OCR, and morpheme analysis to be applied to an input image;

FIG. 32C is a view showing an example of processes of character region recognition, OCR, and morpheme analysis to be applied to an input image;

FIG. 32D is a view showing an example of processes of character region recognition, OCR, and morpheme analysis to be applied to an input image;

FIG. 33 is a view showing an example of processes of character region recognition, OCR, and morpheme analysis to be applied to an input image;

FIG. 34 is a view showing an example of a data format of metadata added to each object shown in FIG. 33;

FIG. 35 is a block diagram showing an example of processing to be performed by an image processing device according to an embodiment of the present invention; and

FIG. 36 is a view showing an example of details of a data processing device in FIG. 2.

### DESCRIPTION OF THE EMBODIMENTS

A first embodiment of an image processing method according to aspects of the present invention will be described with reference to the drawings.

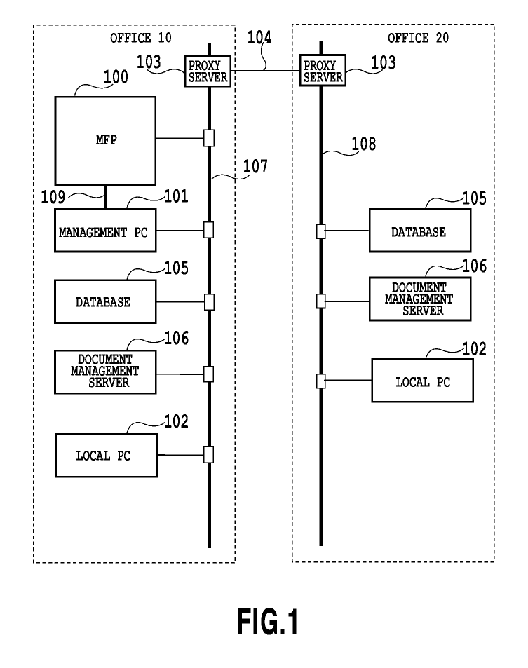

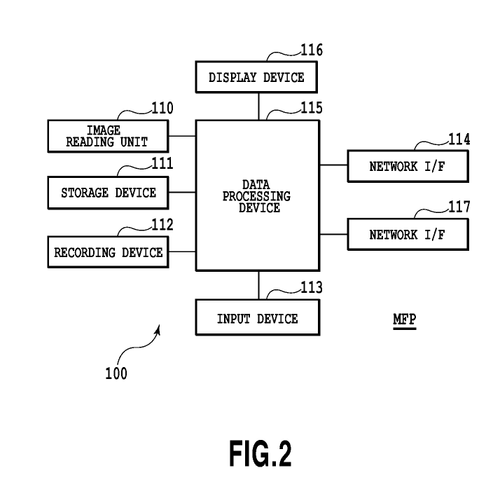

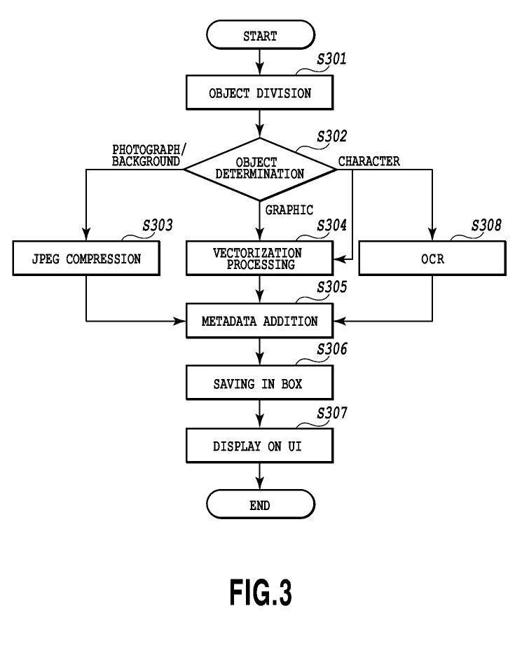

FIG. 1 is a block diagram showing an example of an image processing device of the present embodiment. FIG. 2 is a block diagram showing an example of an MFP as shown in the image processing device of FIG. 1, and FIG. 3 is an example of a first data processing flow described according to the first embodiment.

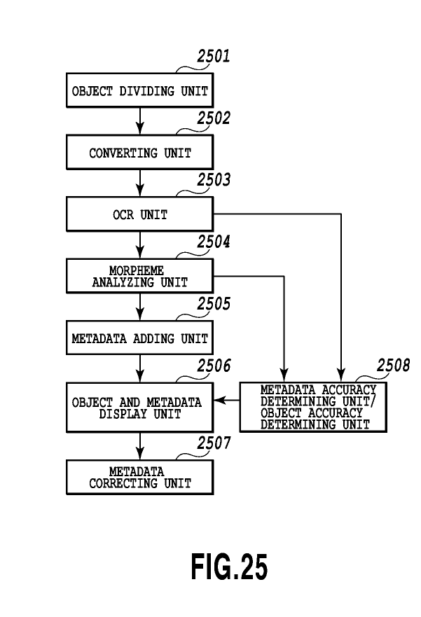

FIG. 25 shows an example of processing to be performed in the image processing device in the first embodiment. In other words, the first embodiment may be executed by the units indicated by the reference numerals 2501 to 2508. According to this example, the reference numeral 2501 indicates an object dividing unit. The reference numeral 2502 indicates a converting unit. The reference numeral 2503 indicates an OCR unit. The reference numeral 2504 indicates a morpheme analyzing unit. The reference numeral 2505 indicates a metadata adding unit. The reference numeral 2506 indicates an object and metadata display unit. The reference numeral 2507 indicates a metadata correcting unit. The reference numeral 2508 indicates a metadata accuracy determining unit.

According to this example, the OCR unit 2503 is connected to the metadata accuracy determining unit 2508, and the morpheme analyzing unit 2504 is connected to the metadata accuracy determining unit 2508. The metadata accuracy determining unit 2508 is connected to the object and metadata display unit 2506.

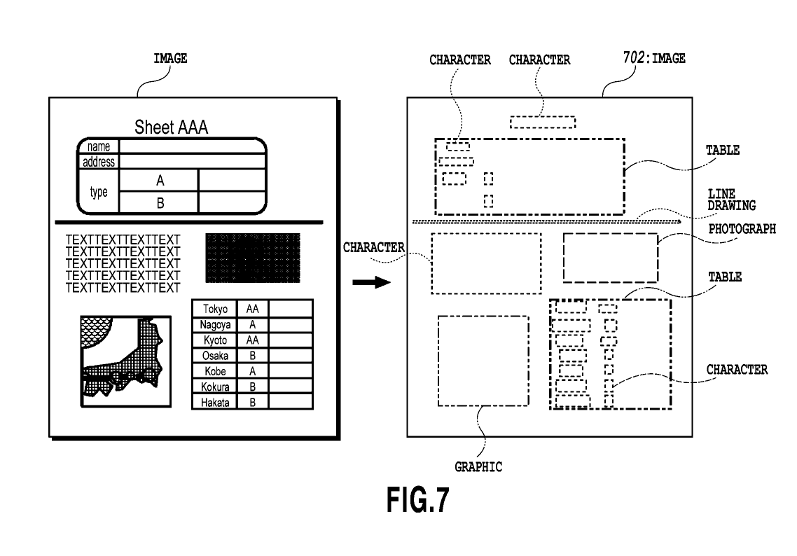

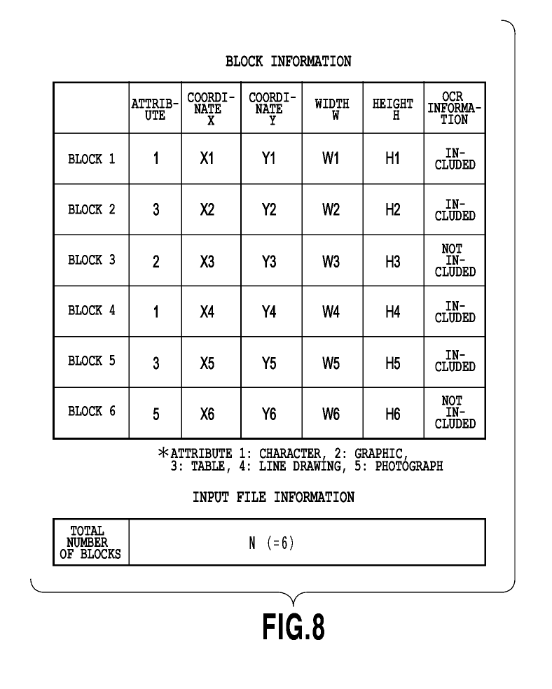

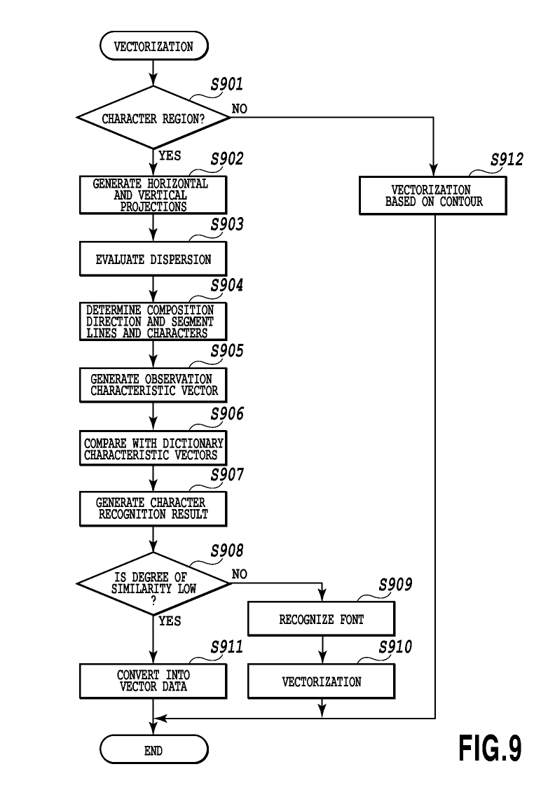

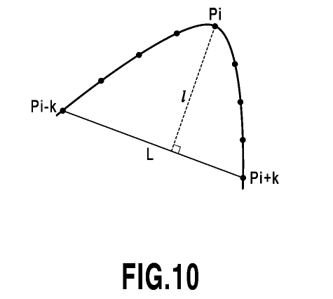

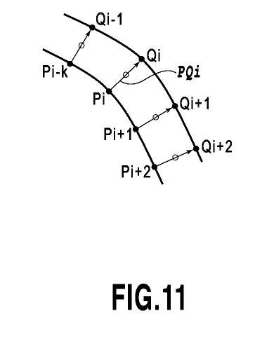

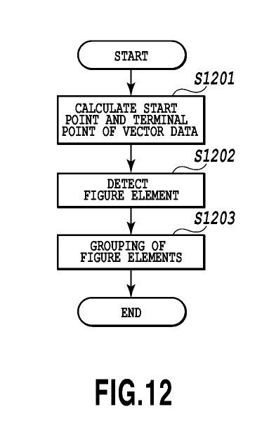

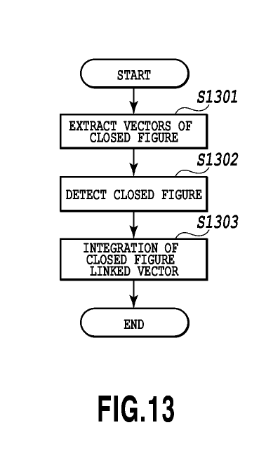

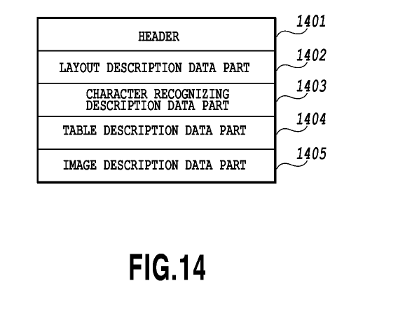

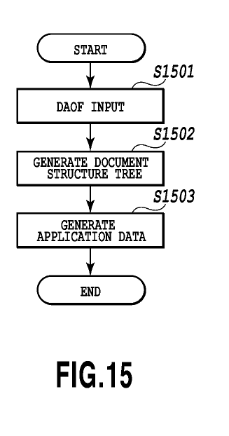

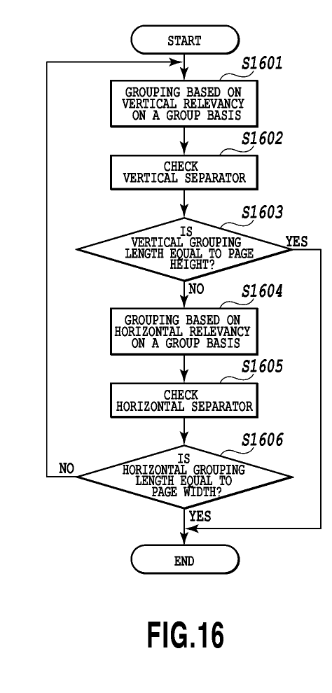

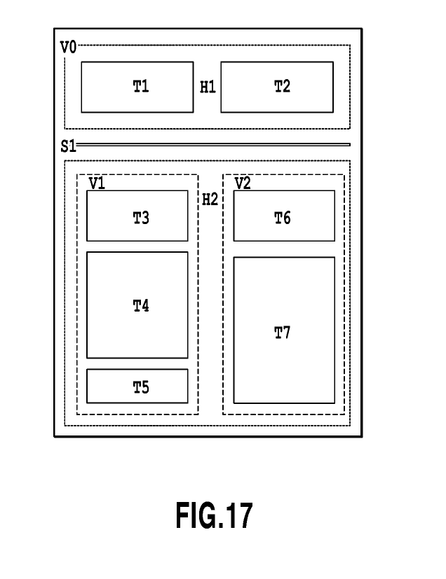

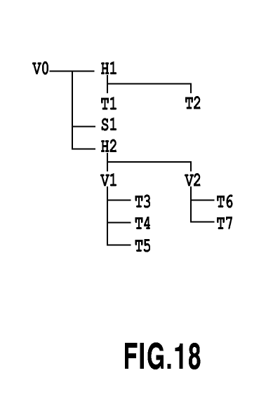

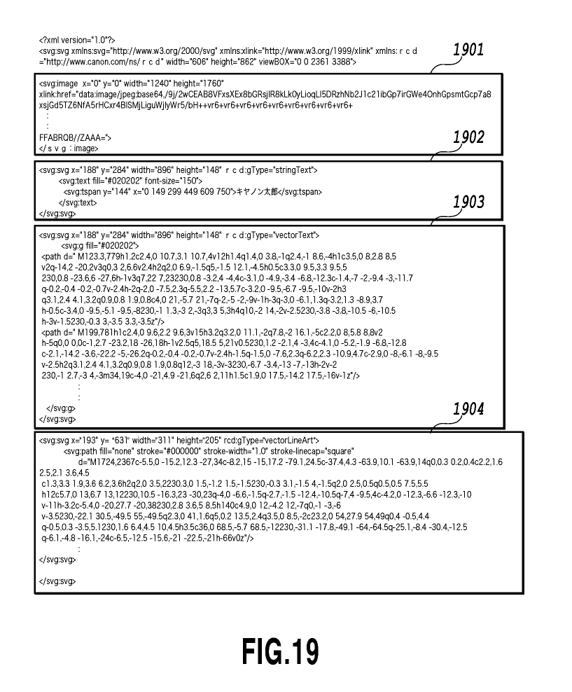

FIG. 7 shows an example of a result of region division obtained through object division processing performed by vectorization processing. FIG. 8 shows an example of block information for each attribute and input file information at the time of object division. FIG. 9 is a flowchart of an example of the vectorization processing for conversion into reusable data. FIG. 10 shows an example of corner extraction processing in the vectorization processing. FIG. 11 shows an example of contour compiling processing in the vectorization processing. FIG. 12 is a flowchart showing an example of grouping processing of vector data generated through the processing shown in the example of FIG. 9. FIG. 13 is a flowchart of an example of figure element detection processing to be applied to the vector data grouped through the processing shown in the example of FIG. 12. FIG. 14 shows an example of a data structure of a vectorization processing result according to the present embodiment. FIG. 15 is a flowchart showing an example of application data conversion processing as shown in the example of FIG. 11. FIG. 16 is a flowchart showing an example of document structure tree generation processing as shown in the example of FIG. 15. FIG. 17 shows an example of a document to be subjected to the document structure tree generation processing. FIG. 18 shows an example of a document structure tree to be generated through the processing of the example shown in FIG. 16. FIG. 19 shows an example of a Scalable Vector Graphics (SVG) format described in the present embodiment.

### [Image Processing System]

In FIG. 1, the image processing device of the present embodiment may be used in an environment in which an office 10 and an office 20 are connected by the Internet 104.

In this embodiment, to a LAN 107 constructed in the office 10, a multi-functional printer (MFP) 100 as a recording device, a management PC 101 which controls the MFP 100, a local PC 102, a document management server 106, and a database 105 for the document management server 106 may be connected.

A LAN 108 may be constructed in the office 20, and to the LAN 108, a document management server 106 and a database 105 for the document management server 106 may be connected.

To the LANs 107 and 108, proxy servers 103 may be connected, and the LANs 107 and 108 may be connected to the Internet via the proxy servers 103.

According to this embodiment, the MFP 100 may take charge of a part of image processing to be applied to an input image read from a document. An image processed by the MFP 100 can be input into the management PC 101 via the LAN 109. The MFP 100 may interpret Page Description Language (hereinafter, abbreviated to PDL) transmitted from the local PC 102 or a general-purpose PC, and may function as a printer a swell. Further, the MFP 100 may have a function for transmitting an image read from a document to the local PC 102 or a general-purpose PC.

According to this embodiment, the management PC 101 may be a computer including at least one of an image storage unit, an image processing unit, a display unit, and an input unit, and parts of these may be functionally integrated with the MFP 100 and become components of the image processing device. According to aspects of the present embodiment, registration processing, etc., described below may be executed in the database 105 via the management PC, however, it may also be allowed that the processing to be performed by the management PC is executed by the MFP.

Further, the MFP 100 may be directly connected to the management PC 101 by the LAN 109.

### [MFP]

In the embodiment as shown in FIG. 2, the MFP 100 includes an image reading unit 110 having an auto document feeder (hereinafter, abbreviated to ADF). In one version, this image reading unit 110 irradiates an image on a sheaf of documents or on a one-page document with light by a light source, and forms a reflected image on a solid-state image pickup device by a lens. The solid-state image pickup device may generate image reading signals with a predetermined resolution (for example, 600 dpi) at a predetermined luminance level (for example, 8 bits), and from the image reading signals, an image comprising raster data may be generated.

The MFP 100 according to this embodiment includes a storage device (hereinafter, referred to as BOX) 111 and a recording device 112, and when executing a copying function, it may perform conversion into recording signals by copying image processing by the data processing device 115 on image data. When copying a plurality of pages, after recording signals of one page are temporarily stored and held in the BOX 111 and then sequentially output to the recording device 112, a recorded image may be formed on a recording paper.

The MFP 100 may have a network I/F 114 for connection to the LAN 107. The MFP 100 may record a PDL to be output by using a driver from the local PC 102 or another general-purpose PC not shown by the recording device 112. PDL data which is output from the local PC 102 via the driver may be interpreted and processed by the data processing device 115 after being sent through the network I/F 114 from the LAN 107, and converted into recordable recording signals. Thereafter, in the MFP 100, the recording signals may be recorded as a recorded image on a recording paper.

The BOX 111 may have a function capable of saving data obtained by rendering data from the image reading unit 110 and the PDL data output from the local PC 102 via the driver.

The MFP 100 may be operated through a key operating unit (input device 113) provided on the MFP 100 or an input device (keyboard, pointing device) of the management PC 101. For such operation, the data processing device 115 may execute predetermined control by a control unit installed inside.

The MFP 100 may also have a display device 116, and may display an operation input state and image data to be processed by the display device 116.

The BOX 111 may be directly controlled from the management PC 101 via the network I/F 117. The LAN 109 may be used for exchanging data and control signals between the MFP 100 and the management PC 101.

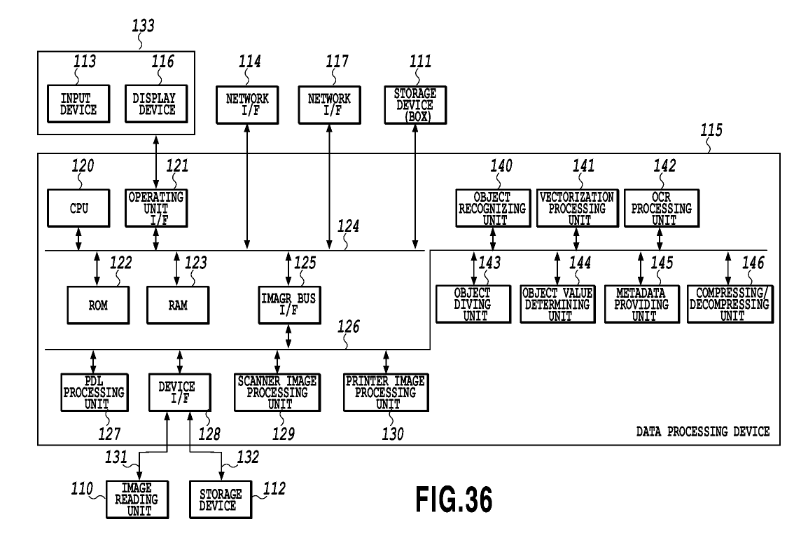

Next, details of the embodiment of the data processing device 115 as shown in FIG. 2 will be described with reference to FIG. 36. As the reference numerals 110 to 116 of FIG. 36 are described above in the description of FIG. 2, the description thereof is being partially omitted below.

According to this embodiment, thee data processing device 115 is a control unit including a CPU and a memory, etc., and is a controller for inputting and outputting image information and device information. Here, the CPU 120 is a controller for controlling the entirety of the device. The RAM 123 is a system work memory for the CPU 120 to operate, and is an image memory for temporarily storing image data. The ROM 122 is a boot ROM storing a boot program of the system. The operating unit I/F 121 is an interface to the operating unit 133, and outputs image data to be displayed on the operating unit 133 to the operating unit 133. In addition, it may perform a role of transmitting information input by a user of the image processing device from the operating unit 133 to the CPU 120. These devices may be arranged on a system bus 124.

An image bus interface (image bus I/F) 125 according to this embodiment may connect the system bus 124 and an image bus 126 which transfers image data at a high speed, and is a bus bridge for converting a data structure. The image bus 126 may comprise, for example, a PCI bus or IEEE 1394. On the image bus 126, the following devices may be arranged. A PDL processing unit 127 may analyze a PDL code and develop it into a bitmap image. The device I/F 128 can connect the image reading unit 110 as an image input/output device and the recording device 112 to the data processing device 115 via a signal line 131 and a signal line 132, respectively, and may perform synchronous/asynchronous conversion of image data. A scanner image processing unit 129 can correct, process, and edit input image data. A printer image processing unit 130 may apply correction and resolution conversion, etc., according to the recording device 112 to print output image data to be output to the recording device 112.

According to one aspect of the invention, the object recognizing unit 140 applies object recognition processing, examples of which are described later, to objects divided by an object dividing unit 143, an embodiment of which is also described later. The vectorization processing unit 141 may apply vectorization processing, an example of which is described later, to objects divided by the object dividing unit 143, as is also described later. The OCR (i.e., character recognition processing) processing unit 142 may apply OCR processing (i.e., character recognition processing) (described later) to the objects divided by the object dividing unit 143 (also described later). The object dividing unit 143 may perform object division (described later). The object value determining unit 144 may perform object value determination (described later) for the objects divided by the object dividing unit 143. The metadata providing unit 145 may provide metadata (described later) to the objects divided by the object dividing unit 143. The compressing/decompressing unit 146 may apply compression and decompression to image data, for example for efficient use of the image bus 126 and the recording device 112.

### [Saving on an Object Basis]

FIG. 3 is a flowchart showing an example for saving a bitmap image on an object basis. Here, bitmap image data may be acquired, for example, by the image reading unit 110 of the MFP 100. On the local PC 102, the bitmap image data may be generated by rendering a document inside the MFP 100. The document may be created by application software.

Processing shown in the example of FIG. 3 may be executed for example by the CPU 120 of as shown in the embodiment of FIG. 36.

First, at Step S301, object division is performed. Object kinds after object division may indicate one or more of characters, photographs, graphics (e.g., drawing, line drawing, and table), and backgrounds. The respective divided objects are left as bitmap data, and the kinds of objects (e.g., character, photograph, graphic, and background) are determined at Step S302 as well.

When an object is determined as a photograph (PHOTOGRAPH/BACKGROUND in Step S302, processing proceeds to Step S303, where it is JPEG-compressed in the form of bitmap. Also, when an object is determined as a background (PHOTOGRAPH/BACKGROUND in Step S302), processing also proceeds to Step S303, where it is JPEG-compressed in the form of bitmap. Processing then proceeds to Step S305.

Next, when an object is determined as a graphic (GRAPHIC in Step S302), processing proceeds to Step S304, where it is vectorized and converted into pass data, after which processing proceeds to Step S305. Finally, when an object is determined as a character (CHARACTER in Step S302), processing also proceeds to Step S304, where it is also vectorized and converted into pass data similar to a graphic, after which processing proceeds to Step S305. Furthermore, when an object is determined as a character (CHARACTER in Step S302), processing also proceeds to Step S308, where it is subjected to OCR processing and converted into character code data, after which processing proceeds to Step S305. All object data and character code data may be filed as one file.

Next, at Step S305, each object is provided with optimum metadata. Each object provided with metadata may be saved in the BOX 111 installed inside the MFP 100 at Step S306. The saved data may be displayed on a UI (user interface) screen by the display device 116 at Step S307, after which processing may be ended.

### [Creation of Bitmap Image Data]

### <Input to Image Reading Unit of MFP 100>

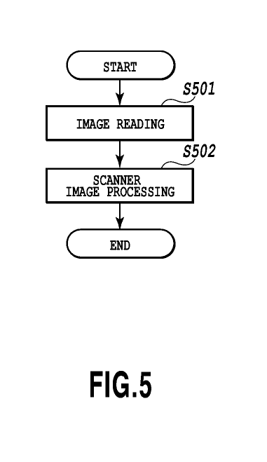

According to one embodiment, when the image reading unit 110 of the MFP 100 is used, at Step S501 as shown in the example of FIG. 5, an image may be read into the MFP 100 by the image reading unit 110. The image read into the MFP 100 is already bitmap image data. This bitmap image data may be subjected to image processing dependent on a scanner by the data processing device 115 at Step S502, after which processing may be ended. Image processing dependent on a scanner unit may include, for example, color processing and filtering processing.

### <When Using Application Software on Local PC 102>

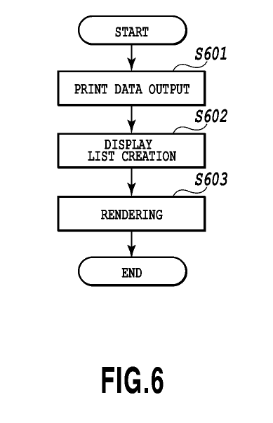

According to one embodiment, application data created by using application software on the local PC 102 may be converted into print data via a print driver on the local PC 102 and transmitted to the MFP 100 at Step S601 shown in the example of FIG. 6. Here, print data means PDL, for example, at least one of LIPS or Postscript® (registered trademark). Next, at Step S602, a display list may be generated via an interpreter inside the MFP 100. Next, at Step S603, by rendering the display list, bitmap image data may be generated, after which the process may be ended.

Bitmap image data generated in the above-described two examples may be divided into objects at Step S301.

### [Metadata Addition (Step S307)]

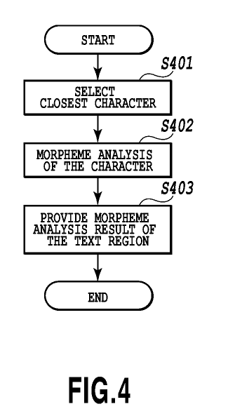

FIG. 4 is a flowchart relating to an example of metadata addition in Step S305.

Processing shown in the example of FIG. 4 may be executed by the CPU 120 as shown in the embodiment of FIG. 36.

In the processing example shown in FIG. 4, first, at Step S401, a character object around the object and at the shortest distance from the object is selected. Next, at Step S402, the selected character object is subjected to morpheme analysis. A part or the whole of a word extracted through the morpheme analysis is added as metadata to each object at Step S403.

In one version for creating the metadata, not only the morpheme analysis but also one or more of image characteristic amount extraction and construction analysis can be used.

### [Detailed Setting of Registration]

FIG. 19 shows an example of a format of data vectorized at the vectorization processing Step S304 of FIG. 3. In the present embodiment, the data is described in the SVG format, however, the format is not limited to this.

In FIG. 19, by way of explanation, the descriptions of objects are surrounded by frames. The frame 1901 shows an image attribute, and in this frame, region information showing a region of an image object and bitmap information are shown. In the frame 1902, character object information is expressed, and in the frame 1903, contents shown in the frame 1902 are expressed as a vector object. The frame 1904 shows a line art such as a table object.

### [Object Dividing Step]

Object division may be performed by using a region dividing technique. Hereinafter, an example is described.

According to this example, at Step S301 (object dividing step), like the image 702 shown in the right half of FIG. 7, an input image is divided into rectangular blocks by attribute. As described above, attributes of rectangular blocks may be at least one of character, photograph, and graphic (e.g., drawing, line drawing, and table).

At the object dividing step, first, image data stored in a RAM is binarized to be monochrome, and a pixel cluster surrounded by black pixel contours is extracted.

Further, the size of the black pixel cluster thus extracted is evaluated, and contour tracing is performed for a white pixel cluster inside the black pixel cluster with a size not less than a predetermined value. Internal pixel cluster extraction and contour tracing are recursively performed in such a way that the size of a white pixel cluster is evaluated and a black pixel cluster inside the white pixel cluster is traced, as long as the size of the internal pixel cluster is not less than the predetermined value.

The size of a pixel cluster may be evaluated based on, for example, an area of the pixel cluster.

Rectangular blocks circumscribed to pixel clusters thus obtained may be generated, and attributes may be determined based on the sizes and shapes of the rectangular blocks.

For example, a rectangular block which has an aspect ratio close to 1 and a size in a certain range may be defined as a character-corresponding block which is likely to be a character region rectangular block, and when character-corresponding blocks in proximity to each other are regularly aligned, the following processing may be performed. That is, a new rectangular block assembling these character-corresponding blocks may be generated, and the new rectangular block may be defined as a character region rectangular block.

A flat pixel cluster or a black pixel cluster which is not smaller than a predetermined size and includes circumscribed rectangles of white pixel clusters in quadrilateral shapes arranged without overlapping, may be defined as a table graphic region rectangular block, and other amorphous pixel clusters may be defined as photograph region rectangular blocks.

At the object dividing step, for each of the rectangular blocks thus generated, attribute block information and input file information, as shown in the example of FIG. 8, may be generated.

In the example shown in FIG. 8, the block information includes an attribute, position coordinates X and Y, width W, height H, and OCR information of each block. The attribute is provided in the form of a value of 1 to 3, and the value of 1 shows a character region rectangular block, 2 shows a photograph region rectangular block, and 3 shows a table graphic region rectangular block. The coordinates X and Y are X and Y coordinates of a start point (e.g., coordinates of the upper left corner) of each rectangular block in the input image. The width W and the height H are the width in the X coordinate direction and the height in the Y coordinate direction of the rectangular block. OCR information shows whether there is pointer information in the input image.

Further, as input file information, a total number N of blocks showing the number of rectangular blocks may be included.

These pieces of block information of the respective rectangular blocks may be used for vectorization in a specific region. When synthesizing a specific region and another region, a relative position relationship between these can be identified from the block information, so that without changing the layout of the input image, a vectorized region and a raster data region can be synthesized.

### [Vectorizing Step]

Vectorization is performed by using a vectorization technique. Hereinafter, an example will be described.

Step S304 (vectorizing step) may be executed through each step shown in the example of FIG. 9.

Through the processing executed at each step in the example of FIG. 9, objects divided through the object dividing step are converted into morphemes which are not dependent on the resolution according to the object attributes.

The processing shown in the example of FIG. 9 may be executed by the CPU 120 as shown in the embodiment of FIG. 36.

In the processing shown in the example of FIG. 9, first, at Step S901, it is determined whether a specific region is a character region rectangular block. Then, when the specific region is determined as a character region rectangular block (YES in Step S901), the process advances to Step S902 and subsequent steps, the specific region is recognized by using a method of pattern matching, and accordingly, a character code corresponding to the specific region is obtained. At Step S901, when it is determined that the specific region is not a character region rectangular block (NO in Step S901), the process shifts to Step S912.

At Step S902, for determining whether the specific region is in a horizontal writing direction or vertical writing direction(e.g., composition direction determination), horizontal and vertical projections are applied to pixel values in the specific region.

Next, at Step S903, a dispersion of the projection of Step S902 is evaluated. When the dispersion of the horizontal projection is great, it is determined as horizontal writing, and when the dispersion of the vertical projection is great, it is determined as vertical writing.

Next, at Step S904, based on the evaluation result of Step S903, the composition direction is determined, lines are segmented, and then characters are segmented to obtain character images.

Decomposition into character strings and characters may be performed as follows. That is, when the character strings are written horizontally, by using horizontal projection, lines of character strings are segmented, and by using vertical projection on the segmented lines, characters are segmented. When character strings are written vertically, processing reversed in regard to the horizontal and vertical directions may be performed. At this time, when segmenting lines and characters, character sizes are also detected.

Next, at Step S905, regarding each character segmented at Step S904, observation characteristic vectors are generated by converting characteristics obtained from the character images into numeric strings of several dozen dimensions. Various methods can be used for extraction of characteristic vectors. For example, a method can be used in which a character is divided into meshes, and several dimensional vectors obtained by counting character lines in the meshes as linear elements in each direction are used as characteristic vectors.

Next, at Step S906, observation characteristic vectors obtained at Step S905 and dictionary characteristic vectors obtained in advance for each kind of font are compared, and distances between the observation characteristic vectors and the dictionary characteristic vectors are calculated.

Next, at Step S907, the distances calculated at Step S906 are evaluated, and a kind of font at the shortest distance is determined as a recognition result.

Next, at Step S908, the degree of similarity is determined by determining whether the shortest distance is larger than a predetermined value in the distance evaluation of Step S907. When the degree of similarity is not less than a predetermined value, there is every possibility that the character is erroneously recognized as a different character having a similar shape in dictionary characteristic vectors. Therefore, when the degree of similarity is not less than a predetermined value (YES in Step S908), the recognition result of Step S907 is not adopted, and the process advances to Step S911. When the degree of similarity is lower (smaller) than the predetermined value (NO in Step S908), the recognition result of Step S907 is adopted, and the process advances to Step S909.

At Step S909 (font recognizing step), a plurality of dictionary characteristic vectors, used at the time of character recognition, corresponding to the kind of font, are prepared for a character shape kind, that is, the kind of font. Then, at the time of pattern matching, the kind of font is output together with a character code, whereby the character font is recognized.

Next, at Step S910, by using the character code and font information obtained through character recognition and font recognition and by using outline data prepared in advance respectively, each character is converted into vector data. When the input image is a color image, colors of each character are extracted from the color image and recorded together with the vector data, and then the processing is ended.

At Step S911, a character is handled similarly to a general graphic and this character is outlined. In other words, for a character which is highly likely to be erroneously recognized, vector data of outlines visually faithful to the image data is generated, and then processing is ended.

At Step S912, when the specific region is not a character region rectangular block, vectorization processing is executed based on the contour of the image, and then processing is ended.

Through the above-described processing, image information belonging to a character region rectangular block may be converted into vector data which is substantially faithful in shape, size, and color.

### [Vectorization of Graphic Region]

When the specific region is determined as being other than the character region rectangular blocks of Step S301, that is, determined as being a graphic region rectangular block, a contour of a black pixel cluster extracted in the specific region may be converted into vector data.

According to one version, in vectorization of regions other than character regions, first, to express a line drawing as a combination of a straight line and/or a curve, “a corner” dividing the curve into a plurality of sections (e.g., pixel rows) is detected. The corner is a point with a maximum curvature, and determination as to whether the pixel Pi on the curve shown in the example of FIG. 10 is a corner may be performed as follows.

That is, according to this example, Pi is set as a starting point and pixels Pi−k and Pi+k at a distance of predetermined pixels (k) from Pi toward both sides of Pi along the curve are connected by a line segment L. The pixel Pi is determined as a corner when d2 becomes maximum or the ratio (d1/A) is not more than a threshold, where d1 is the distance between the pixels Pi−k and Pi+k, d2 is the distance between the line segment L and the pixel Pi, and A is the length of an arc between the pixels Pi−k and Pi+k of the curve.

Pixel rows divided by the corner are approximated to a straight line or a curve. Approximation to a straight line may be executed according to a least square function, and approximation to a curve may be executed by using a cubic spline function. The pixel of the corner dividing the pixel rows becomes a start end or a terminal end of an approximate straight line.

Furthermore, according to this example it is determined whether there is an inner contour of a white pixel cluster inside the vectorized contour, and when there is an inner contour, it is vectorized. Thus, inner contours of inverted pixels are recursively vectorized in such a way that an inner contour of an inner contour is vectorized.

As described above, an outline of a figure in an arbitrary shape may be vectorized through piecewise linear approximation of a contour. When an original document is colored, figure colors may be extracted from a color image and recorded with the vector data.

As shown in the example of FIG. 11, when an outer contour PRj and an inner contour PRj+1 or another outer contour are in proximity to each other in a certain focused section, two or a plurality of contours may be compiled and expressed as a line with a thickness. For example, when the shortest distances PiQi from each pixel Pi of contour Pj+1 to the pixels Qi on the contour PRj are calculated and scattering of PQi is small, the focused section is approximated to a straight line or a curve along the point row of the midpoints Mi between the pixels Pi and Qi. For example, the thickness of the approximate straight line or approximate curve may be approximated by an average of the distances PiQi.

A table rule which is a line or an aggregate of lines may be relatively efficiently expressed by a vector by setting it as an aggregate of lines with thicknesses.

After the contour compiling processing, the entire processing may be ended.

Photograph region rectangular blocks may not be vectorized but may be left as image data.

### [Figure Recognition]

After outlines of line drawings are vectorized as described above, vectorized piecewise lines may be grouped by each figure object.

At each step of the example shown in FIG. 12, processing for grouping vector data by figure object is executed.

The processing shown in the example of FIG. 12 may be executed by the CPU 120 as shown in the embodiment of FIG. 36.

In the processing example shown in FIG. 12, first, at Step S1201, a start point and a terminal point of each vector data are calculated.

Next, at Step S1202 (i.e., figure element detection), by using information on the start point and terminal point obtained at Step S1201, a figure element is detected. According to this example, the figure element is a closed figure created by piecewise lines, and when detecting the element, the vectors are linked by a common corner pixel which is a start point and a terminal point. Here, the principle that each vector of a closed figure has vectors linked to both ends thereof is applied.

Next, at Step S1203, other figure elements or piecewise lines in the figure element are grouped into one figure object. When there are no other figure elements or piecewise lines inside the figure element, the figure element is defined as a figure object.

### [Detection of Figure Element]

An example of processing of Step S1202 (i.e., figure element detection) may b e executed through each step as shown in the example of FIG. 13.

The processing example of FIG. 13 may be executed by the CPU 120 as shown in the embodiment of FIG. 36.

In the processing example shown in FIG. 13, first, at Step S1301, vectors which are not linked to both ends are removed from the vector data, and vectors of the closed figure are extracted.

Next, at Step S1302, regarding the vectors of the closed figure, starting from an end point (e.g., start point or terminal point) of any vector, vectors are sequentially searched in a constant direction, for example, clockwise. In other words, at the other end point, an end point of another vector is searched, and end points the closest to each other within a predetermined distance are set as end points of a linked vector. When searching is finished for one round of vectors of the closed figure and returns to the starting point, searched vectors are all grouped into a closed figure of one figure element. In addition, all vectors of the closed figure inside the closed figure are also grouped. Further, a start point of a vector which has not been grouped is set as a starting point and the same processing is repeated.

Lastly, at Step S1303, among the vectors removed at Step S1301, vectors whose endpoints are in proximity to the vectors grouped as a closed figure at Step S1302 are detected and grouped as one figure element.

Through the above-described processing example, figure blocks can be handled as individual reusable figure objects.

### [BOX Saving Processing]

After the object dividing step (Step S301) shown in the example of FIG. 3, by using data obtained as a result of vectorization (Step S304), conversion processing into BOX saved data may executed. The vectorization processing result of Step S304 is saved in the format of intermediate data as shown in the example of FIG. 14, that is, the format called Document Analysis Output Format (DAOF).

As shown in the example of FIG. 14, the DAOF has a data structure including a header 1401, a layout description data part 1402, a character recognizing description data part 1403, a table description data part 1404, and an image description data part 1405.

In the header 1401, information on the input image to be processed is held.

In the layout description data part 1402, information on one or more of characters, line drawings, drawings, tables, and photographs as attributes of rectangular blocks in the input image and position information of each rectangular block whose attributes are recognized are held.

In the character recognizing description data part 1403, among character region rectangular blocks, character recognition results obtained through character recognition are held.

In the table description data part 1404, details of a table structure of graphic region rectangular blocks having table attributes are stored.

In the image description data part 1405, image data in the graphic region rectangular blocks are segmented from the input image data and held.

Regarding blocks in a specific region which is instructed to be vectorized, in the image description data part 1405, an aggregate of data indicating internal structures of the blocks obtained through vectorization processing, shapes of images, and character codes are held.

On the other hand, regarding rectangular blocks which are not subjected to vectorization processing and are out of the specific region, input image data are held without change.

Conversion processing into BOX saved data may be executed through each step as shown in the example of FIG. 15.

The processing shown in the example of FIG. 15 may be executed by the CPU 120 as shown in the embodiment of FIG. 36.

In the processing example shown in FIG. 15, first, data in the DAOF format is input at Step S1501.

Next, at Step S1502, a document structure tree which becomes an original form of application data is generated.

Next, at Step S1503, based on the document structure tree, real data in DAOF is acquired and actual application data is generated.

The document structure tree generation processing of Step S1502 may be executed through each step as shown in the example of FIG. 16. As ground rules of overall control in the processing example shown in FIG. 16, the process flow shifts from micro blocks (individual rectangular blocks) to a macro block (aggregate of the rectangular blocks). Hereinafter, a “rectangular block” means both of a micro block and a macro block.

Processing shown in the example of FIG. 16 may be executed by the CPU 120 as shown in the embodiment of FIG. 36.

In the processing shown in the example of FIG. 16, first, at Step S1601, on a rectangular block basis, rectangular blocks are re-grouped (e.g., grouping is performed) based on vertical relevancy. The processing shown in FIG. 16 may be repeated, however, immediately after starting the processing, determination is made on a micro block basis. Here, a group obtained by grouping based on relevancy may be referred to as “relevant group.”

Here, relevancy is defined according to characteristics showing that the blocks are at a short distance or have substantially the same block width (height in the horizontal orientation). Information on the distance, width, and height, etc., are extracted by referring to DAOF.

In the image data shown in the example of FIG. 17, in the image V0 of the uppermost region, rectangular blocks T1 and T2 are aligned horizontally. Below the rectangular blocks T1 and T2, a horizontal separator S1 is present, and below the horizontal separator S1, rectangular blocks T3, T4, T5, T6 and T7 are present.

The rectangular blocks T3, T4, and T5 are aligned vertically from the upper side to the lower side in the left half in the group V1 in the region below the horizontal separator S1. The rectangular blocks T6 and T7 are aligned vertically in the right half in the group V2 in the region below the horizontal separator S1.

Then, grouping processing based on vertical relevancy of Step S1601 is executed. Accordingly, the rectangular blocks T3, T4, and T5 are assembled into one group (rectangular block) V1, and the rectangular blocks T6 and T7 are assembled into one group (rectangular block) V2. The groups V1 and V2 are in the same hierarchy.

Returning to the processing example of FIG. 16, at Step S1602, it is checked whether there is a vertical separator. The separator is an object having a line attribute in DAOF, and has a function for explicitly dividing blocks in application software. When a separator is detected, in the hierarchy to be processed, the input image region is divided into left and right regions by using the separator as a border. The image data shown in FIG. 17 includes no vertical separator.

Next, at Step S1603, it is determined whether a sum of the group heights in the vertical direction becomes equal to the height of the input image. In other words, in the case of horizontal grouping while shifting the region to be processed vertically (for example, from the upper region to the lower region), by using the fact that the sum of group heights becomes the input image height when the processing is finished for the entirety of the input image, it is determined whether the processing has been finished. When grouping is finished (YES in Step S1603), the process is directly ended, and when the grouping is not finished (NO in Step S1603), the process is advanced to Step S1604.

Next, grouping processing based on horizontal relevancy is executed at Step S1604. Accordingly, the rectangular blocks T1 and T2 are assembled into one group (rectangular block) H1, and the rectangular blocks V1 and V2 are assembled into one group (rectangular block) H2. The groups H1 and H2 are in the same hierarchy. Here, determination is also made on a micro block basis immediately after starting the processing.

Next, at Step S1605, it is checked whether a horizontal separator is present. When a separator is detected, in the hierarchy to be processed, the input image region is divided into upper and lower regions by using the separator as a border. The image data shown in the example of FIG. 17 includes a horizontal separator S1.

The result of the above-described processing is registered as a tree for example as shown in FIG. 18.

In the example of FIG. 18, the input image V0 includes the groups H1 and H2 and the separator S1 in the highest hierarchy, and the rectangular blocks T1 and T2 in the second hierarchy belong to the group H1.

The groups V1 and V2 in the second hierarchy belong to the group H2, the rectangular blocks T3, T4, and T5 in the third hierarchy belong to the group V1, and the rectangular blocks T6 and T7 in the third hierarchy belong to the group V2.

Next, at Step S1606, it is determined whether the total of horizontal group lengths becomes equal to the width of the input image. Accordingly, an end of horizontal grouping is determined. When the horizontal group length is the page width (YES in Step S1606), the document structure tree generation processing is ended. When the horizontal group length is not the page width (NO in Step S1606), the process returns to Step S1601, and in one higher hierarchy, the processing is repeated from the vertical relevancy check.

### [Data Format of Metadata]

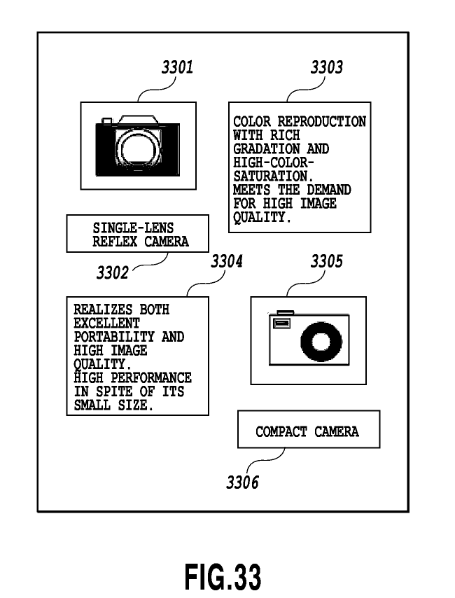

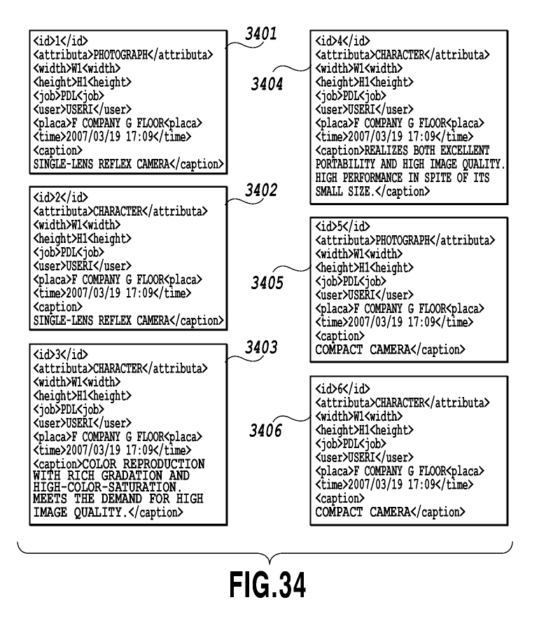

FIG. 33 shows an example of an input image. In FIG. 33, objects 3301 to 3306 show objects obtained through object division. FIG. 34 shows data formats of metadata added to the objects 3301 to 3306. In FIG. 34, data formats 3401 to 3406 correspond to the objects 3301 to 3306, respectively. The data formats of these metadata can be converted into data formats for display and displayed on a screen by a display method described later.

Hereinafter, the data format of metadata will be described by using the object 3301.

<id>1</id> of 3401 in the example of FIG. 34 is data showing an area ID of the object 3301, and <attribute>photo</attribute> is data showing an attribute of the object 3301. As described above, the objects may have attributes of one or more of a character, photograph, and graphic, and these may be determined at Step S301 described above. <width>W1</width> is data showing the width of the object 3301, and <height>H1</height> is data showing the height of the object 3301. <job>PDL</job> shows a job type of the object 3301, and as described above, in bitmap data generation, in the case of input into the image reading unit of MFP 100, the job type is SCAN. When application software on the local PC 102 is used, the job type is PDL. <user>USER1</user> is data showing user information of the object 3301. <place>G-th floor, F company</place> is data showing information on an installation location of the MFP. <time>2007/03/1917:09</time> is data showing the time of the input. <caption> single-lens reflex camera</caption>is data showing caption of the object 2601.

### [Display Method]

Next, an embodiment of a UI which is displayed at Step S307 in the example of FIG. 3 will be described in detail.

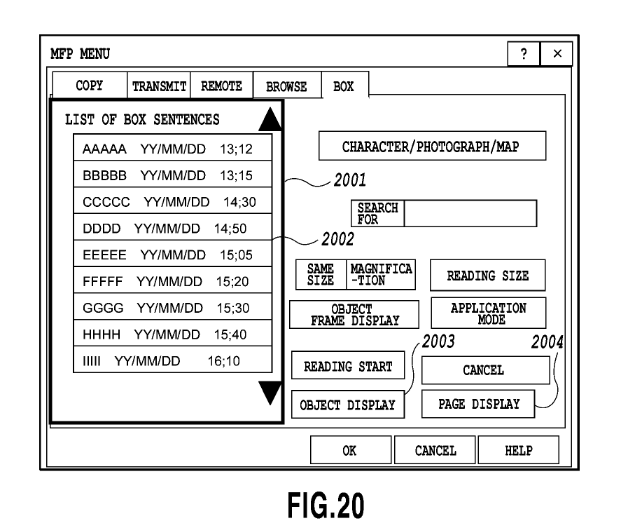

FIG. 20 shows an example of a user interface. In the example of FIG. 20, in the region 2001, data saved in the BOX are displayed. In the user interface shown in FIG. 20, in the region 2002, each sentence has a name, and information such as a time of the input, etc., are also displayed. In the case of object dividing display, when a document is selected in the region 2001 and the object display button 2003 is pressed down, the display changes. An example of the object dividing display will be described later. When a document is selected in the region 2001 and the page display button 2004 is pressed down, the display changes. An example of this will be described in detail later.

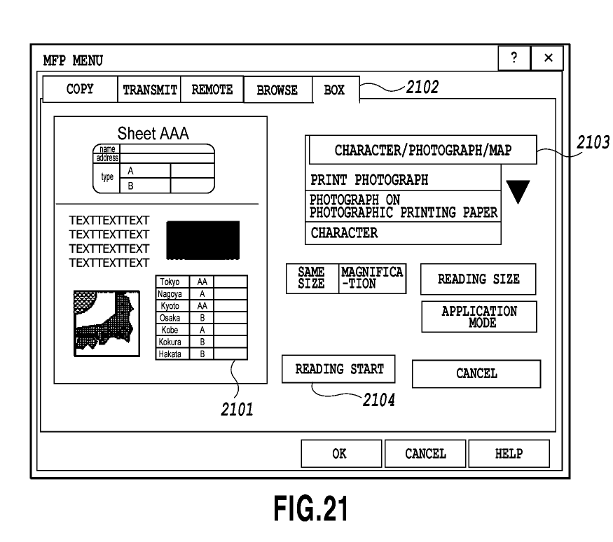

FIG. 21 shows an example of a user interface. In the region 2101 of FIG. 21, data saved at Step S306 are displayed. In the region 2101, an image obtained by minifying a raster image is also displayed, and display using SVG, for example as described above, is also performed. In other words, the whole page may be displayed in the region 2101 based on the above-described data. The function tabs 2102 are used for selecting functions of the MFP such as copying, transmitting, remote operations, browser, and BOX. The function tabs 2102 may be used for selecting other functions. The document modes 2103 are used for selecting a document mode when reading a document. The document mode is selected for switching image processing according to a document type, and modes other than the modes shown here can also be displayed and selected. The button 2104 is pressed down when starting document reading. In response to this pressing-down, the scanner operates and reads an image. In the example shown in FIG. 21, the button 2104 is provided within the screen, however, it may also be provided on another screen.

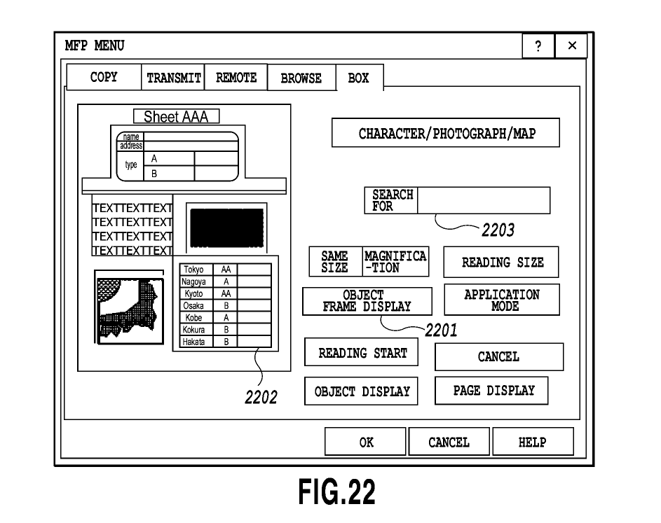

In the user interface example shown in FIG. 22, a frame is displayed around each object so that the result of object division is understood. Here, by pressing the button 2201 down, each object frame is displayed on the page display screen 2202. Display is performed in such a way that differences among objects are understood by coloring the frames, and differences among objects are understood depending on line thicknesses or a difference between a dotted line and a dashed line. Here, the kinds of objects are character, drawing, line drawing, table, and photograph. The display 2203 is for inputting characters for search. By inputting a character string in the display 2203 and performing search, an object or a page including the object is searched. By using a search method, based on the above-described metadata, an object or page may be searched. Further, a searched object or a page including the object may be displayed.

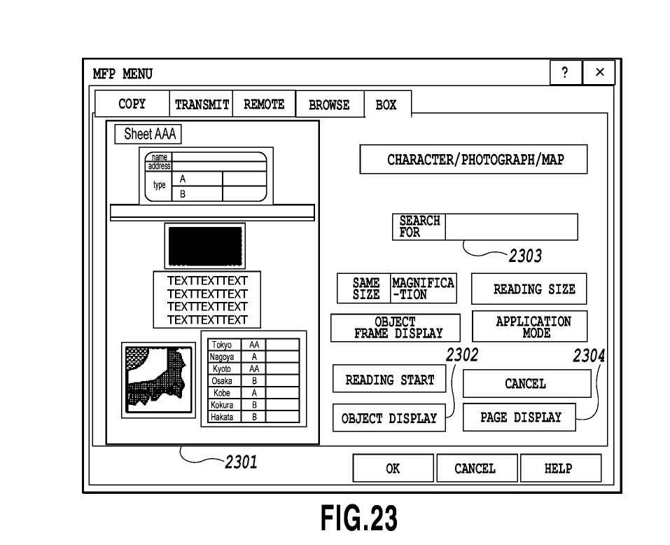

FIG. 23 shows an example of a user interface in which objects in the page are displayed by pressing the object display 2302 down. In the region 2301, the concept of page is not used, but each object is displayed as a component. When the page display 2304 is pressed, switched display is performed so that the objects are seen as an image in one page. The display 2303 is for inputting characters for search. By inputting a character string into the display 2303 and performing search, an object or a page including the object is searched. By using a search method, based on metadata described above, an object or a page including the object may be searched. A searched object or page including the object may be displayed.

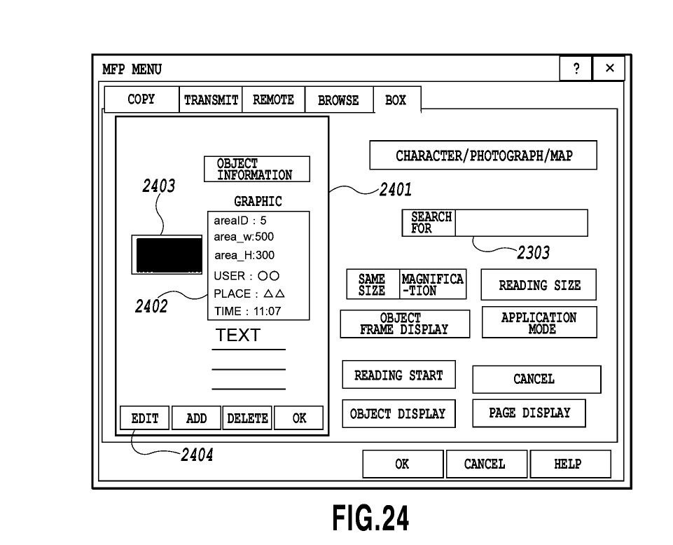

FIG. 24 shows an example of a user interface for displaying metadata of an object. When a certain object is selected, in the region 2401, an image 2403 of the object and the metadata 2402 described above obtained by converting data formats of metadata added as described above into a display data format are displayed. As the metadata, information such as one or more of area information, width, height, user information, information on installation location of the MFP, and information on the time of the input of the image, etc., may be displayed. Here, in this example, the object has a photograph attribute, and by using morpheme analysis, lexical categories such as nouns and verbs are identified, decomposed, and taken out from OCR information of a character object near the photograph object, and displayed. The result is a character string “TEXT” shown in the region 2401. By pressing the button 2404, metadata can be edited, added, and deleted.

Next, by using another drawing example, an aspect of the present embodiment will be further described.

Hereinafter, unless otherwise noted, “metadata” means words decomposed into lexical categories by applying morpheme analysis to a character string extracted from a character object.

Also, as metadata added to the object may be different from metadata that a user expects, due to errors in OCR processing and morpheme analysis, a unit for correcting this may be provided.

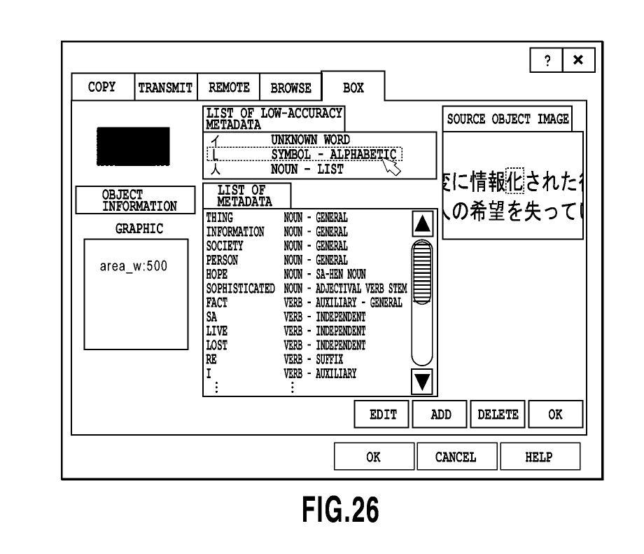

FIG. 25 shows an example of processing to be performed in the image processing device of the present embodiment. FIG. 26 shows an example of a user interface of the image processing device of the present embodiment.

By using the results of processing of the OCR unit 2503 and the morpheme analyzing unit 2504, metadata with low accuracy may be determined in the metadata accuracy determining unit 2508. According to this determination result, in the object and metadata display unit 2506, display of the metadata is controlled. An example of a search for incorrect metadata and a correction processing flow will be described in more detail below.

As described above, as shown in FIG. 24, when a user designates an object, the image 2403 of the object and metadata 2402 thereof are displayed. A plurality of metadata may be added to an object by the metadata adding unit 2505, so that when displaying metadata, a list of the metadata is displayed by the object and metadata display unit 2506. At this time, as shown in FIG. 26, metadata likely to be corrected are preferentially (e.g., selectively) displayed as a “list of low-accuracy metadata.”

Here, preferential display means that, according to the prescribed metadata accuracy determining unit 2508 (described in further detail later), specific metadata are extracted from among the metadata and displayed. Preferential display may include a display where specific metadata are extracted from among the metadata and emphatically displayed. Preferential display may also include a display where only specific metadata are extracted from among all of the metadata and displayed, for example without displaying the remaining metadata. In other words, preferential display may include, for example, at least one of display by changing the display color of the specific metadata from the color of other metadata and emphatic display by positioning the specific metadata higher than others in the list. These displays may be automatically performed as default, or may be performed, for example, when a user requests changing of the display method.

When a user who confirmed the preferentially displayed metadata with low accuracy determines that the metadata is incorrect, the UI accepts designation of the corresponding metadata from the user. When a user presses the edit button 2404, the CPU which accepted the designation may perform at least one of editing, adding, and deleting the metadata.

The above-described metadata accuracy determining unit 2508 determines accuracies showing whether the added metadata are incorrect.

Into the metadata accuracy determining unit 2508, the results of processing of the OCR unit 2503 and the morpheme analyzing unit 2504 are input, and accuracies of these are determined.

The determination method may be as follows.

The lexical categories obtained through morpheme analysis may include a lexical category the kind of which cannot be identified and which is taken as an unknown word. This may be caused by an OCR error or a morpheme analysis error, so that such metadata is very likely to be incorrect metadata. Even when a word is identified as a noun, if it is identified as a one-character noun, there is a possibility that such a word is caused by an OCR error or a morpheme error.

Therefore, such words may be extracted as metadata with low accuracy, and output to the object and metadata display unit.

Thus, in the present embodiment, by preferentially displaying metadata which should be corrected, the time and the number of operations performed by the user for correcting the incorrect metadata can be reduced and the usability can be improved.

Next, a second embodiment of the image processing method of the present invention will be described with reference to the drawings.

In the first embodiment, the usability relating to the correction of metadata that has been erroneously added is improved. In this method, objects are selected one by one and it is confirmed whether metadata thereof are correct, and when the metadata are incorrect, the metadata are corrected.

In the second embodiment, an image processing device in which incorrect metadata can be relatively accurately and quickly searched for and corrected, even when a fairly large amount of objects are held, will be described.

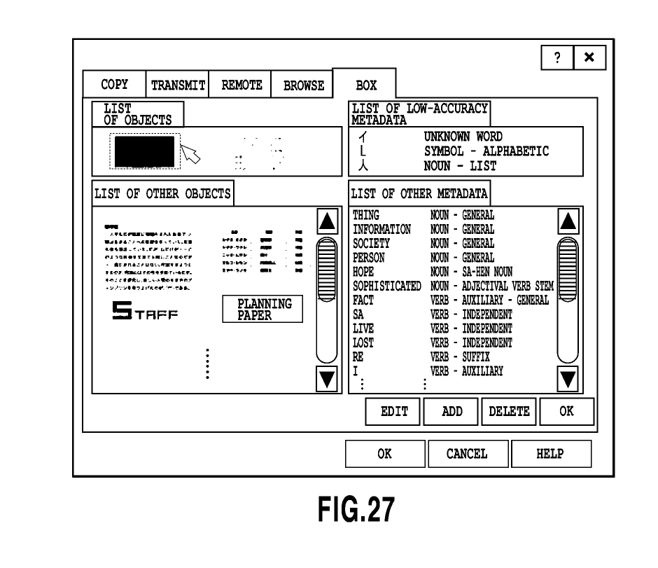

A block diagram showing the image processing device to which the present embodiment is applied is the same as the example of FIG. 25. FIG. 27 shows an example of a user interface of the image processing device in the present embodiment.

In the present embodiment, a point of difference from the first embodiment is that a list of objects including metadata with low accuracy may be displayed in the object and metadata display unit. In this case, as shown in the example of FIG. 27, objects including metadata which should be corrected are preferentially (e.g., selectively) displayed as a “list of low-accuracy metadata.”

Here, preferential display means that specific metadata are extracted from among the metadata and displayed. Preferential display may include a display where specific metadata are extracted from among the metadata and emphatically displayed. Preferential display may also include a display where only specific metadata are extracted from among all of the metadata according to a prescribed object accuracy determining unit 2508 (described in further detail later) and displayed, for example without displaying the remaining metadata. In other words, preferential display may include, for example, at least one of display by changing the display color of the specific metadata from the color of other metadata and emphatic display by positioning the specific metadata higher than others in the list. These displays may be automatically performed as default, or may also be performed, for example, when a user requests changing of the display method. The display may also be executed only when there is an object to which metadata that is very likely to be incorrect over a predetermined threshold set by the user has been added.

The above-described object accuracy determining unit 2508 determines accuracies showing whether incorrect metadata have been added to the objects. Into the object accuracy determining unit 2508, the results of processing of the OCR unit 2503 and the morpheme analyzing unit 2504 are input, and accuracies of these are determined. At this time, accuracies may be determined according to the above-described method.

For example, as shown in the example of FIG. 27, objects added with metadata in which the number and frequency of appearances of unknown words and one-character nouns are great, are displayed specifically or in an emphatic manner in the displayed list.

Thus, in the present embodiment, by preferentially displaying objects including metadata which should be corrected, the time and number of operations performed by the user in searching for the metadata which should be corrected can be reduced, and the usability can be improved.

Next, a third embodiment of the image processing method of the present invention will be described with reference to the drawings.

In the first embodiment and the second embodiment, for example, when a user designates a certain photograph object and confirms metadata added thereto, it may in certain cases be difficult to determine whether the metadata are correct simply by looking at the photograph object. Furthermore, if the metadata are incorrect, the correction may proceed on a one by one basis, and even when they are caused by the same OCR error or morpheme analysis error, the correction may be performed for the same number of times as the derived metadata.

In the present embodiment, an image processing device that may be capable of at least partially solving this problem, and that may enable relatively efficient correction of metadata by a user, will be described.

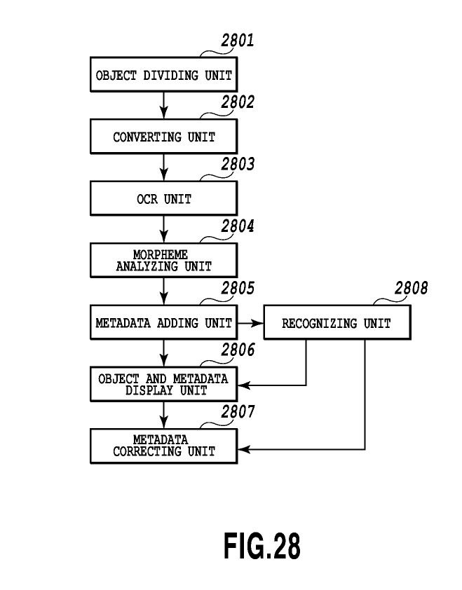

FIG. 28 shows an example of processing to be performed in the image processing device of the present embodiment.

In other words, the third embodiment may be executed by unit indicated by the reference numerals 2801 to 2808. The reference numeral 2801 indicates an object dividing unit. The reference numeral 2802 indicates a converting unit. The reference numeral 2803 indicates an OCR unit. The reference numeral 2804 indicates a morpheme analyzing unit. The reference numeral 2805 indicates a metadata adding unit. The reference numeral 2806 indicates an object and metadata display unit. The reference numeral 2807 indicates a metadata correcting unit. The reference numeral 2808 indicates a recognizing unit.

The recognizing unit 2808 is connected to the object and metadata display unit 2806 and the metadata correcting unit 2807, and the metadata adding unit 2805 is connected to the recognizing unit 2808.

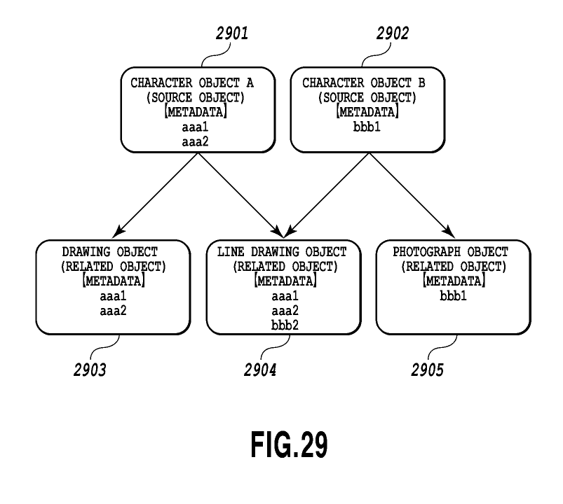

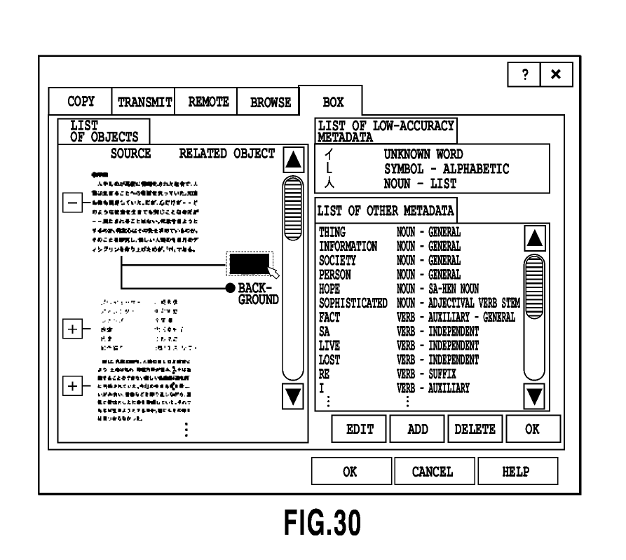

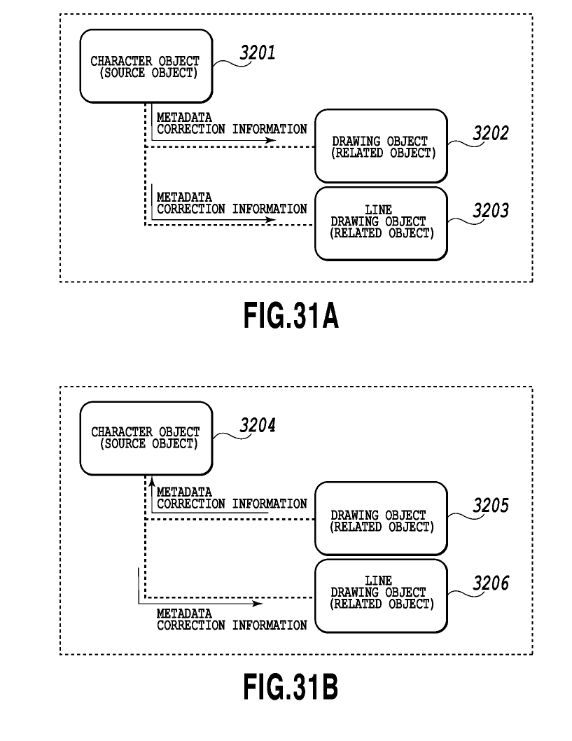

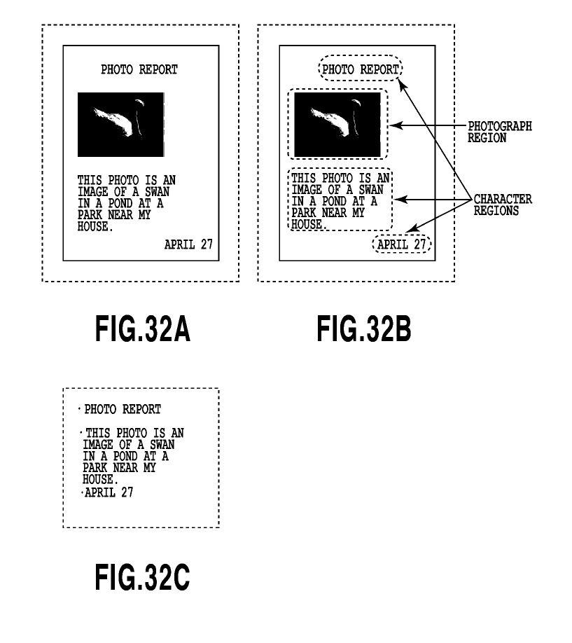

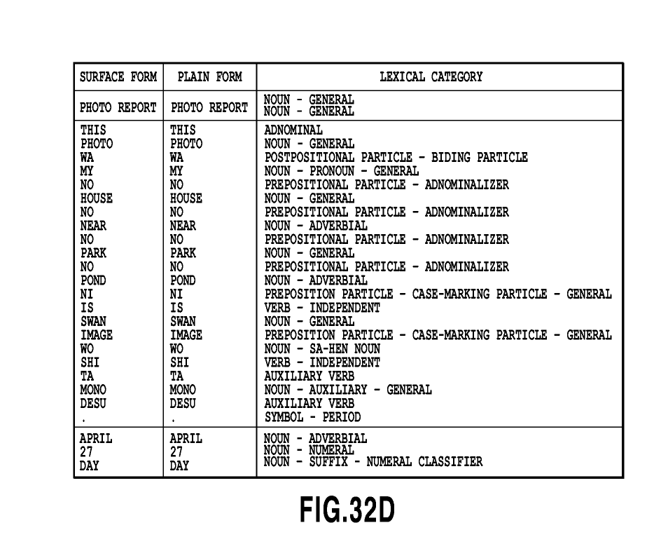

FIG. 29 shows an example of the relationship between metadata of character objects and objects having no character codes relating to the character objects. FIG. 30 shows an example of a user interface of an image processing device to which the present embodiment is applied. FIGS. 31A and 31B are views describing an example of correction of metadata in the image processing device to which the present embodiment is applied.

As shown in the example of FIG. 29, related objects (2903, 2904, and 2905) of a drawing, a line drawing, and a photograph in the image read have no character code by themselves. To the related object, character codes of the source objects (2901 and 2902) of relevant character objects around the related character object are added as metadata. In the recognizing unit 2808, to each object, link information showing which object the object relates to is added.

In detail, upon providing the objects with different IDs unique to the respective objects, IDs of source and related objects are recorded as metadata on an object basis.

By referring to the example of FIG. 30, a method for displaying lists of objects and metadata for a user will be described. When objects are listed, to the related object, the same metadata as those of the source object are added. Therefore, when incorrect metadata is included, the source object of the incorrect metadata may be more preferentially displayed (e.g., displayed with higher priority) than the related object. Here, preferential display includes a case where the source object is set as a root category and displayed in an emphatic manner, and the related object is set as a sub category of the source object and displayed in an unemphatic manner or is held in a state where an operation may be required to display the related object.

By referring to the examples of FIG. 31A and FIG. 31B, an example of a method for correcting metadata will be described in the present embodiment. FIG. 31A is a view schematically showing an example of a state where a source object is corrected, and FIG. 31B is a view schematically showing an example of a case where related objects are corrected.

In other words, whichever metadata of the source object or the related object is corrected, the correction may be automatically reflected in metadata of objects linked to the source or related object.

For example, in FIG. 31A, metadata of the character object (source object) 3201 are corrected, and the correction is automatically reflected in the drawing object (related object) 3202. In addition, metadata of the character object (source object) 3201 are corrected and the correction is automatically reflected in the line drawing object (related object) 3203.

As another example, in FIG. 31B, metadata of the drawing object (related object) 3205 are corrected and the correction is automatically reflected in the character object (source object) 3204. In addition, metadata of the character object (source object) 3204 are corrected and the correction is automatically reflected in the line drawing object (related object) 3206.

Thus, according to aspects of the present embodiment, a user may be able to relatively easily know which source object the metadata added to a related object is derived from, and may be able to relatively easily determine whether the metadata are correct while confirming a character image of the source object. Concurrently, according to one aspect, in metadata derived from the same source object, simply by correcting one metadata, other metadata may also be relatively easily corrected, so that the time and the number of operations performed by a user for correcting metadata can be reduced and the usability can be improved.

Next, a fourth embodiment of the image processing method according to the present invention will be described with reference to the drawing.

In the first, second, and third embodiments, for example, when the same image as an input image whose metadata are corrected is input again, there is a possibility that metadata having the same incorrect aspects may also be added. Therefore, in the present embodiment, an image processing device which may be capable of at least partially solving such a problem and that may make it unnecessary for a user to repeat the same correction, will be described.

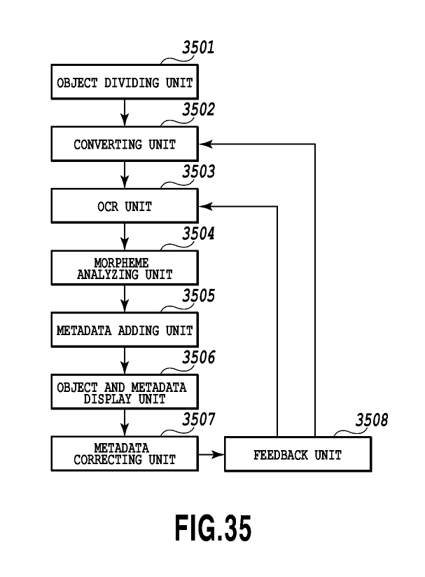

FIG. 35 shows an example of processing to be performed in the image processing device of the present embodiment.

In other words, the fourth embodiment is executed by the unit indicated by the reference numerals 3501 to 3508. The reference numeral 3501 indicates an object dividing unit. The reference numeral 3502 indicates a converting unit. The reference numeral 3503 indicates an OCR unit. The reference numeral 3504 indicates a morpheme analyzing unit. The reference numeral 3505 indicates a metadata adding unit. The reference numeral 3506 indicates an object and metadata display unit. The reference numeral 3507 indicates a metadata correcting unit. The reference numeral 3508 indicates a feedback unit.

The feedback unit 3508 is connected to the converting unit 3502 and the OCR unit 3503. The metadata correcting unit 3507 is connected to the feedback unit 3508.

In the image processing device of the fourth embodiment shown in the example of FIG. 35, a point of difference from the first, second, and third embodiments may be as follows. That is, in the fourth embodiment, a feedback unit which changes the contents of an OCR dictionary and a morpheme analysis dictionary by using contents of correction made by the metadata correcting unit 3507, may be included. Accordingly, in subsequent OCR processing and morpheme analysis, dictionaries reflecting the contents of correction made by a user may be referred to.

As a result, correction made by a manual operation can be reflected in subsequent metadata addition, and accordingly, the accuracy of metadata generation may be improved, and it may become unnecessary for a user to repeat the same correction.

According to one aspect of the present invention, metadata which are highly likely to be incorrect and objects having such metadata are preferentially displayed, so that when a user searches for and corrects incorrectly added metadata, the search may be relatively easy. In addition, contents of the correction made by a user's manual operation may also be reflected in other metadata generated from the same error, and metadata including the same kind of error can be corrected at a time. The contents of the correction made by a user may be reflected in metadata generation along with subsequent image input.

According to one aspect, a processing method in which, to realize the functions of the above-described embodiments, a program having computer-executable instructions for operating the configurations of the embodiments described above is stored in a storage medium, and the computer-executable instructions stored in the storage medium are read as codes and executed in a computer, may also be included in the scope of the above-described embodiments. As well as the storage medium storing the computer-executable instructions, the program having the computer-executable instructions itself may also be included in the above-described embodiments.

As such a storage medium, for example, at least one of a floppy disk, a hard disk, an optical disk, a magneto-optical disk, a CD-ROM, a magnetic tape, a nonvolatile memory card, and a ROM can be used.

Aspects of the invention are not limited to an embodiment in which processing is executed by computer-executable instructions alone stored in a storage medium, and embodiments are also included in which, for example an OS executes operations according to the above-described embodiments, for example in association with functions of other kinds of software and extension board.

While the present invention has been described with reference to exemplary embodiments, it is to be understood that the invention is not limited to the exemplary embodiments disclosed herein. Accordingly, the scope of the following claims is to be accorded the broadest interpretation so as to encompass all such modifications and equivalent structures and functions.

This application claims the benefit of Japanese Patent Application No. 2008-033574, filed Feb. 14, 2008, which is hereby incorporated by reference herein in its entirety.

What is claimed is:

1. An image processing device comprising:
a dividing unit for dividing objects of an input image;
a metadata adding unit for adding metadata to each of the divided objects by performing OCR processing and morpheme analysis;
a display unit for displaying at least one of the divided objects, and the metadata added to the divided object, and
a metadata accuracy determining unit for determining accuracies of the added metadata, wherein
the display unit preferentially displays metadata determined as being low in accuracy by the metadata accuracy determining unit.

2. The image processing device according to claim 1, wherein the metadata accuracy determining unit determines a word determined to be an unknown word through morpheme analysis as being metadata with low accuracy.

3. The image processing device according to claim 1, wherein the metadata accuracy determining unit determines a word which is determined to be a noun through morpheme analysis, and consists of one character, as being metadata with low accuracy.

4. The image processing device according to claim 1, wherein the display unit displays only metadata determined as being low in accuracy by the metadata accuracy determining unit.

5. The image processing device according to claim 1, wherein the display unit displays metadata determined as being low in accuracy by the metadata accuracy determining unit in an emphatic manner.

6. The image processing device according to claim 1, further comprising: an object accuracy determining unit for determining a divided object as being low in accuracy when the divided object includes a large amount of metadata determined as being low in accuracy by the metadata accuracy determining unit, or when metadata determined as being low in accuracy by the metadata accuracy determining unit has been added to the divided object, wherein
the display unit preferentially displays the divided object determined as being low in accuracy by the object accuracy determining unit.

7. The image processing device according to claim 6, wherein the display unit displays a divided object determined as being low in accuracy by the object accuracy determining unit in an emphatic manner.

8. The image processing device according to claim 1, further comprising:
a recognizing unit for recognizing a source object having metadata which are characters extracted from the divided object and related objects around the source object, as a relevant group; and
a metadata correcting unit for correcting metadata determined as being low in accuracy by the metadata accuracy determining unit, wherein
the metadata correcting unit applies a correction that is the same as a correction of the metadata applied to other objects recognized as being in the same relevant group by the recognizing unit.

9. The image processing device according to claim 8, wherein metadata corrected by the metadata correcting unit are reflected in an OCR dictionary and a morpheme analysis dictionary.

10. An image processing method comprising:
dividing objects of an input image;
adding metadata to each of the divided objects by performing OCR processing and morpheme analysis;
displaying at least one of the divided objects and the metadata added to the divided object, and
determining accuracies of the added metadata, wherein
metadata determined as being low in accuracy is preferentially displayed.

11. The image processing method according to claim 10, wherein determining accuracies of the added metadata includes determining a word determined to be an unknown word through morpheme analysis as being metadata with low accuracy.

12. The image processing method according to claim 10, wherein determining accuracies of the added metadata includes determining a word determined to be a noun through morpheme analysis, and that consists of one character, as being metadata with low accuracy.

13. The image processing method according to claim 10, wherein only metadata determined as being low in accuracy is displayed.

14. The image processing method according to claim 10, wherein the metadata determined as being low in accuracy is displayed in an emphatic manner.

15. The image processing method according to claim 10, further comprising: determining a divided object as being low in accuracy when the divided object includes a large amount of metadata determined as being low in accuracy, or when metadata determined as being low in accuracy has been added to the divided object, wherein
the divided object determined as being low in accuracy is preferentially displayed.

16. The image processing method according to claim 15, wherein the divided object determined as being low in accuracy is displayed in an emphatic manner.

17. The image processing method according to claim 10, further comprising:
recognizing a source object having metadata which are characters extracted from the divided object and related objects around the source object, as a relevant group; and
correcting metadata determined as being low in accuracy, wherein
a correction is applied that is the same as a correction of the metadata applied to other objects recognized as being in the same relevant group.

18. The image processing method according to claim 17, wherein corrected metadata are reflected in an OCR dictionary and a morpheme analysis dictionary.

19. A computer-readable storage medium storing computer-executable instructions for image processing, the computer-readable storage medium comprising:
computer-executable instructions for dividing objects of an input image;
computer-executable instructions for adding metadata to each of the divided objects by performing OCR processing and morpheme analysis;
computer-executable instructions for displaying at least one of the divided objects and metadata added to the divided object, and
computer-executable instructions for determining accuracies of the added metadata, wherein metadata determined as being low in accuracy is preferentially displayed.
